(19) United States
(12) Patent Application Publication
(10) Pub. No.: US 2025/0119248 A1
(43) Pub. Date: Apr. 10, 2025

(54) METHOD AND DEVICE TO RECEIVE PHYSICAL DOWNLINK CONTROL CHANNEL

(71) Applicant: Samsung Electronics Co., Ltd., Gyeonggi-do (KR)

(72) Inventors: Jingxing FU, Beijing (CN); Feifei SUN, Beijing (CN)

(21) Appl. No.: 18/836,207

(22) PCT Filed: Feb. 16, 2023
(86) PCT No.: PCT/KR2023/002293

§ 371 Date: Aug. 6, 2024

(30) Foreign Application Priority Data
Feb. 18, 2022 (CN) 202210151703.9

(51) Int. Cl. H04L 5/00; H04L 27/26

(52) U.S. Cl. CPC H04L 5/0044; H04L 5/0007; H04L 27/261

(57) ABSTRACT

The disclosure relates to a 5G or 6G communication system for supporting a higher data transmission rate. The present disclosure provides a method and device for receiving and transmitting information. According to an aspect of the present disclosure, a method for a network device is provided, which includes transmitting cell configuration information to a terminal device, wherein the cell configuration information includes a first downlink configuration information and a first uplink configuration information, and also includes at least one of a second uplink configuration information and a second downlink configuration information. The first uplink and the first downlink are related in frequency domain; wherein the second uplink satisfies at least one of the following conditions: the second uplink and the first downlink are related in frequency domain; the second uplink and the first uplink are related in frequency domain, wherein the second downlink satisfies at least one of the following conditions: the second downlink and the first downlink are related in frequency domain; the second downlink and the second uplink are related in frequency domain, and receiving, from the terminal device, an uplink signal transmitted by the terminal device based on the cell configuration information.

### TECHNICAL FIELD

The present application relates to a technical field of wireless communication, in particular to a method and a device for receiving a physical downlink control channel (PDCCH).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

Transmission from a base station to a User Equipment (UE) is called downlink, and transmission from a UE to a base station is called uplink.

### Disclosure of Invention

### Technical Problem

There was a need to consider the interference condition of CRS of LTE when receiving the physical downlink control channel (PDCCH).

### Solution to Problem

According to an embodiment of the present disclosure, there is provided a method performed by a user equipment (UE) in a wireless communication system, including: receiving first information indicating a number of ports for a first reference signal and positions of REs occupied by the first reference signal; and receiving a PDCCH based on at least one of the first information and second information related to the PDCCH, wherein REs occupied by a second reference signal in the PDCCH do not overlap with the REs occupied by the first reference signal.

In an implementation, wherein the second information includes a number and/or positions of the REs occupied by the second reference signal in the PDCCH.

In an implementation, wherein the first information is received from a base station, and wherein the second information is received from a base station or is preset.

In an implementation, wherein receiving a PDCCH based on at least one of the first information and second information related to the PDCCH further includes: receiving the PDCCH based on a mapping relationship between the number of ports for the first reference signal and the positions of the REs occupied by the first reference signal and positions of the REs occupied by the second reference signal in the PDCCH.

In an implementation, wherein the mapping relationship is related to the number of the REs occupied by the second reference signal in the PDCCH indicated in the second information.

In an implementation, wherein control information in the PDCCH occupies REs that do not overlap with the REs occupied by the second reference signal and the REs occupied by the first reference signal.

In an implementation, wherein the second information includes a ratio of power of the REs occupied by the second reference signal in the PDCCH to power of the REs occupied by the control information in the PDCCH, and the ratio is determined based on the first information or is received from a base station.

In an implementation, wherein the second information includes third information related to a control channel element aggregation level (CCE AL) of a PDCCH candidate.

In an implementation, the method further includes: receiving fourth information indicating that a second OFDM symbol which does not overlap with the REs occupied by the first reference signal uses the same PDCCH receiving configuration as a first OFDM symbol which overlaps with the REs occupied by the first reference signal, and according to the fourth information, receiving the PDCCH in the second OFDM symbol based on at least one of the first information and the second information related to the PDCCH.

According to an embodiment of the present disclosure, there is provided a method performed by a base station in a wireless communication system, including: transmitting first information indicating a number of ports for a first reference signal and positions of REs occupied by the first reference signal to a UE; and transmitting a PDCCH to the UE, wherein REs occupied by a second reference signal in the PDCCH do not overlap with the REs occupied by the first reference signal.

In an implementation, the method further includes: transmitting second information related to the PDCCH to the UE, wherein the second information includes a number and/or positions of the REs occupied by the second reference signal in the PDCCH.

In an implementation, wherein there is a mapping relationship between the positions of the REs occupied by the second reference signal in the PDCCH and the number of ports for the first reference signal and the positions of the REs occupied by the first reference signal.

In an implementation, wherein the mapping relationship is related to the number of the REs occupied by the second reference signal in the PDCCH indicated in the second information.

In an implementation, the control information in the PDCCH occupies REs that do not overlap with REs occupied by the second reference signal and REs occupied by the first reference signal.

In an implementation, wherein the second information includes a ratio of power of the REs occupied by the second reference signal in the PDCCH to power of the REs occupied by the control information in the PDCCH.

In an implementation, wherein the second information includes third information related to a control channel element aggregation level (CCE AL) of a PDCCH candidate.

In an implementation, the method further includes: transmitting fourth information indicating that a second OFDM symbol which does not overlap with the REs occupied by the first reference signal uses the same PDCCH receiving configuration as a first OFDM symbol which overlaps with the REs occupied by the first reference signal to the UE.

According to an embodiment of the present disclosure, there is provided a user equipment (UE) in a communication system, including: a transceiver configured to transmit and receive signals; and a controller coupled to the transceiver and configured to perform operations in methods according to embodiments of the present disclosure.

According to an embodiment of the present disclosure, there is provided a base station in a communication system, including: a transceiver configured to transmit and receive signals; and a controller coupled to the transceiver and configured to perform operations in methods according to embodiments of the present disclosure.

### Advantageous Effects of Invention

The present disclosure provides a method and a device for transmitting and/or receiving a Physical Downlink Control Channel (PDCCH), which can improve reception performance for PDCCH by adjusting configuration of a UE for detecting PDCCH according to an interference condition of CRS of LTE.

### BRIEF DESCRIPTION OF DRAWINGS

The above and other objects and features of exemplary embodiments of the present disclosure will become more apparent from the following description taken in conjunction with the accompanying drawings which exemplarily illustrate embodiments, in which:

FIG. 1 illustrates an example wireless network according to various embodiments of the present disclosure;

FIGS. 2a and 2b illustrate example wireless transmission and reception paths according to the present disclosure.

FIG. 3a illustrates an example UE according to the present disclosure;

FIG. 3b illustrates an example gNB according to the present disclosure;

FIG. 4 illustrates a schematic diagram of resource elements (REs) occupied by CRS;

FIG. 5 illustrates a schematic diagram of determining CORESET;

FIG. 6 illustrates an exemplary flowchart of a method for transmitting and/or receiving PDCCH according to an embodiment;

FIG. 7 illustrates a schematic diagram of a position of DMRS of PDCCH;

FIG. 8 illustrates a schematic diagram of positions of CRS and DMRS;

FIG. 9 illustrates a schematic diagram of a position of CRS; and

FIGS. 10-17 illustrate schematic diagrams of positions of CRS and DMRS.

FIG. 18 illustrates a simplified block diagram of a hardware structure of a communication device according to an embodiment of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

In order to make the purpose, technical scheme and advantages of the present application clearer, the present application will be further explained in detail with reference to the accompanying drawings and examples.

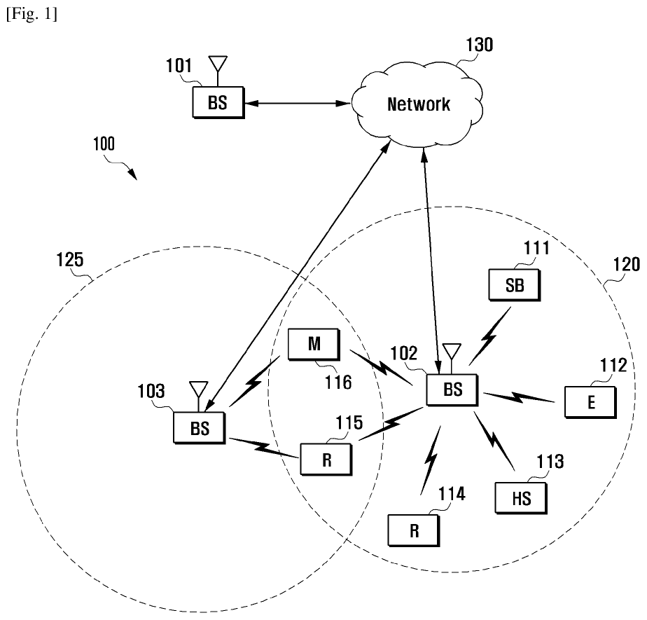

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

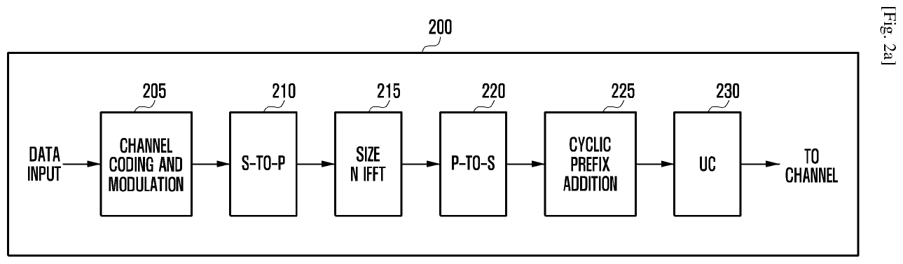

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The upconverter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

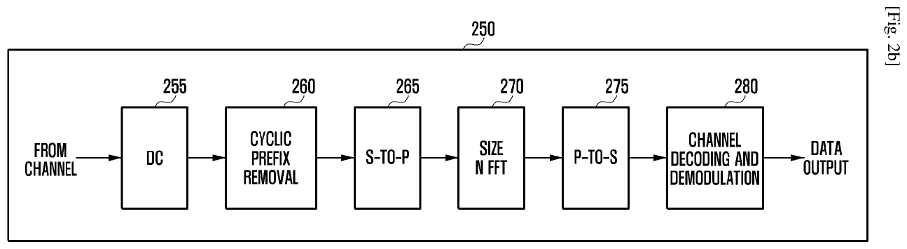

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

It should be understood that schemes provided by the embodiments of the present application may be applied to, but not limited to, the above wireless network.

Technical schemes of the present application and how the technical schemes of the present application solve the above technical problems will be explained in detail with specific embodiments below. The following specific embodiments may be combined with each other, and the same or similar concepts or processes may not be repeatedly described in detail in some embodiments. Embodiments of the present application will be described below with reference to the drawings. The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In order to make the purpose, technical scheme and advantages of the present application clearer, the present application will be further explained in detail with reference to the accompanying drawings and examples.

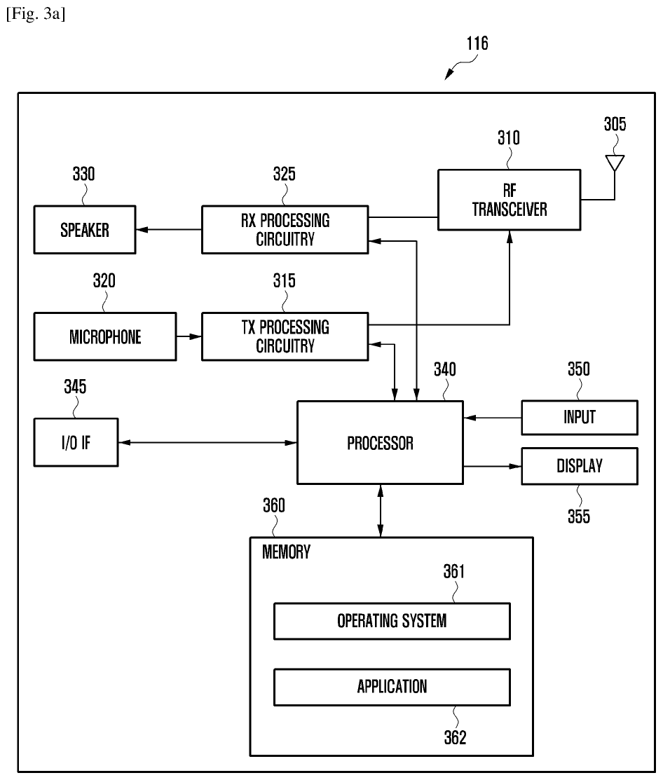

Positions of resource elements (REs) occupied by various reference signals or control information, etc. involved in the following description are only exemplary, for the purpose of facilitating the technical schemes involved in the present application to be understood by those skilled in the art, and are not intended to limit the positions of the REs involved to the specific listed positions. For example, the positions {1, 5, 9} of REs occupied by PDCCH in frequency domain involved in the following description are just examples, which may be other suitable positions. In addition, although the following description refers to a case where CRS in a LTE system interferes with DMRS and/or control information of PDCCH in a new communication system, it should be understood that this is only an example, and it is an exemplary description to make it easier for those skilled in the art to understand the technical schemes of the present application. That is, the technical schemes disclosed in the present application may also be applied to a case where another signal in the LTE system or another communication system interferes with reference signals or control information in the same or different communication system. The Long-term evolution (LTE) system already exists in some frequency spectrums. The LTE system contain a Common Reference Signal (CRS) that is transmitted all the time. As shown in FIG. 4, when there is one port for the CRS, the CRS occupies two REs among 12 resource elements (REs) in one Orthogonal Frequency Division Multiplexing (OFDM) symbol, an interval between which is 6, and positions of the REs may move in frequency domain, which may be one of the following six positions: {0,6}, {1,7}, {2,8}, {3,9}, {4,10} and {5,11}. When there are two ports or four ports for the CRS of LTE, the CRS occupies four REs in one OFDM symbol of one physical resource block (PRB), and possible positions are {1, 7, 4, 10}, {0, 6, 3, 9} and {2, 8, 5, 11}.

In a case where a coexisting new communication system is deployed in a spectrum range within which the LTE coexists, the CRS may interfere with the PDCCH of the new communication system. The present application needs to solve the problem of interference of the CRS of LTE to the PDCCH of the new communication system, so as to improve the reception performance for PDCCH.

In the prior art, there are a total of 12 REs for carrying information in one OFDM symbol in one physical resource block (PRB), in which the DMRS of PDCCH occupies 3 REs, for example, 3 REs located at {1, 5, 9}, and the remaining 9 REs are for PDCCH control information.

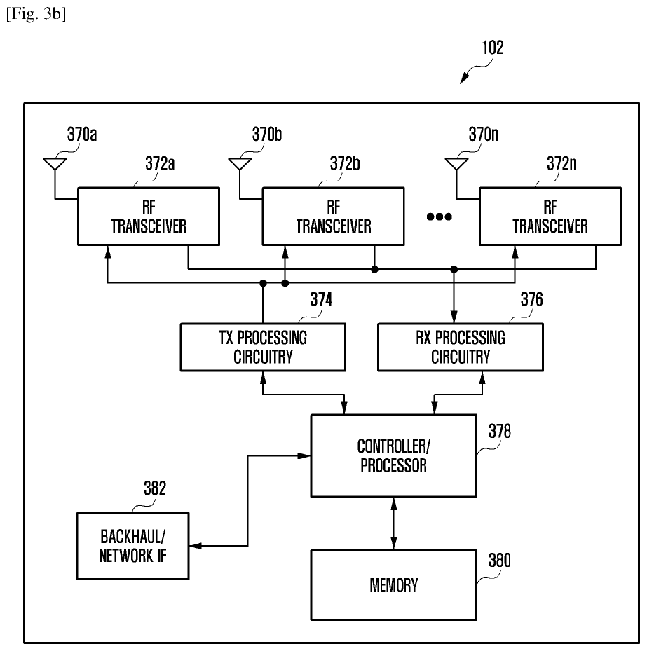

A duration field in a configuration of a CORESET for determining time-frequency resources occupied by a PDCCH candidate is used to configure the number of OFDM symbols occupied by the PDCCH candidate. While a configuration of search space may be used to determine the first symbol of the CORESET of time-frequency resources occupied by the PDCCH candidate, as shown in FIG. 5.

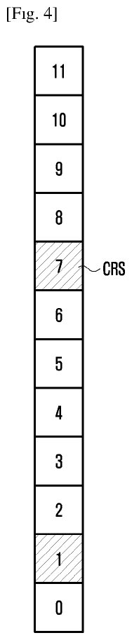

FIG. 6 illustrates an exemplary flowchart of a method 500 for transmitting and/or receiving PDCCH according to an embodiment of the present invention. The method 500 may be implemented at a base station side or a UE side.

As shown in FIG. 6, at step S510 of the method 500, a UE and/or a base station determine a method for receiving and/or transmitting data and control information. For example, the UE determines a configuration for receiving PDCCH by receiving signaling or protocol preset. Alternatively, the base station determines a related configuration for PDCCH.

At step S520, PDCCH is transmitted and/or received according to the determined configuration for transmitting and/or receiving PDCCH.

The configuration for PDCCH may include the number of REs of the Demodulation Reference Signal (DMRS) of the PDCCH and/or the frequency domain positions of the REs of the DMRS, and/or the number of control channel elements (CCEs) included in the PDCCH candidate and/or the maximum value of CCE Aggregation Level (AL). Or it may include a ratio of power of each RE occupied by the DMRS in the PDCCH and power of each RE occupied by the control information of the PDCCH.

The configuration for PDCCH may be determined by the port for the CRS of LTE that overlaps with RE positions occupied by the PDCCH and the frequency domain position of the CRS.

Among them, for the port and frequency domain position of the CRS of LTE, the base station or UE may get it by receiving signaling indication. For example, the base station in the new communication system may receive information about the port and frequency domain position of the CRS from the LTE system. The UE may receive information about the port and frequency domain position of the CRS from the base station.

The signaling may be higher layer signaling or physical layer signaling, etc.

### EMBODIMENT 1

The UE determines the number of the REs occupied by the DMRS of PDCCH and the frequency domain positions of the REs according to signaling.

The UE detects PDCCH according to the number of the REs occupied by the DMRS of PDCCH and the frequency domain positions of the REs.

The signaling may be higher layer signaling configuration or physical layer signaling, etc., which may directly indicate the number of the REs occupied by the DMRS of PDCCH and the frequency domain positions of the REs, for example, it is configured by the higher layer signaling that the number of the REs occupied by the DMRS of PDCCH is 2, and the position is {2, 8}.

The signaling may be another higher layer signaling configuration or physical layer signaling, etc., which may indicate the number of ports for the CRS of LTE and the frequency domain position of the CRS (this signaling may be an existing higher layer signaling for rate matching for PDSCH, lte-CRS-ToMatchAround, or an individual signaling). The UE determines the number of the REs occupied by the DMRS of PDCCH and the frequency domain positions of the REs according to the number of ports for the CRS of LTE and the frequency domain position of the CRS.

The signaling may also be two signaling, in which one signaling indicates the number of ports for the CRS of LTE and/or the frequency domain position of the CRS, and the other signaling indicates the number of the REs occupied by the DMRS of PDCCH. The UE determines the frequency domain positions of the REs occupied by the DMRS of PDCCH according to the number of ports for the CRS of LTE and the frequency domain position of the CRS and the number of the REs occupied by the DMRS of PDCCH.

The signaling may also be signaling indicating the number of ports for the CRS of LTE and/or the frequency domain position of the CRS, and the number of the REs occupied by the DMRS of PDCCH is preset by a protocol (for example, preset to 3).

The UE determines the frequency domain positions of the REs occupied by the DMRS of PDCCH according to the number of ports for the CRS of LTE and/or the frequency domain position of the CRS and the number of the REs occupied by the DMRS of PDCCH.

The method for determining the number of the REs occupied by the DMRS of PDCCH and the frequency domain positions of the REs will be described in detail by way of examples below. The method may be performed by the base station or UE. It should be understood that although some parts of the description herein are mainly described from the perspective of the UE, however, it should be understood that corresponding steps for the methods described in these parts may also be performed by the base station, and then necessary information is notified to the UE.

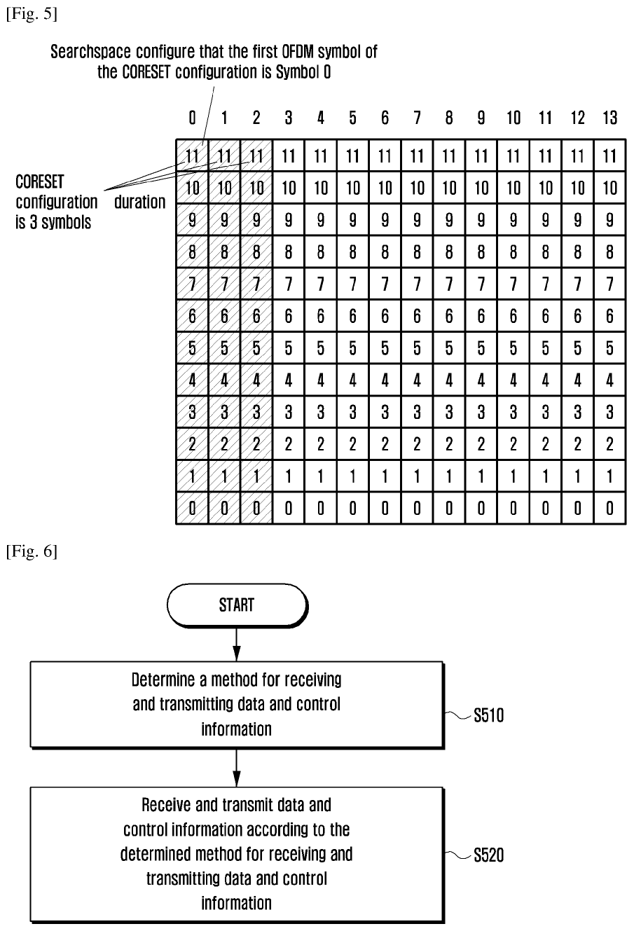

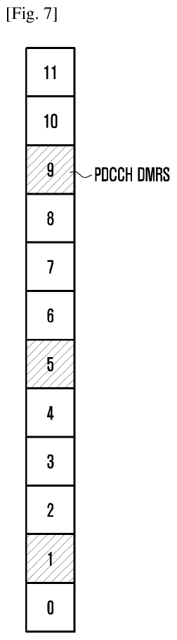

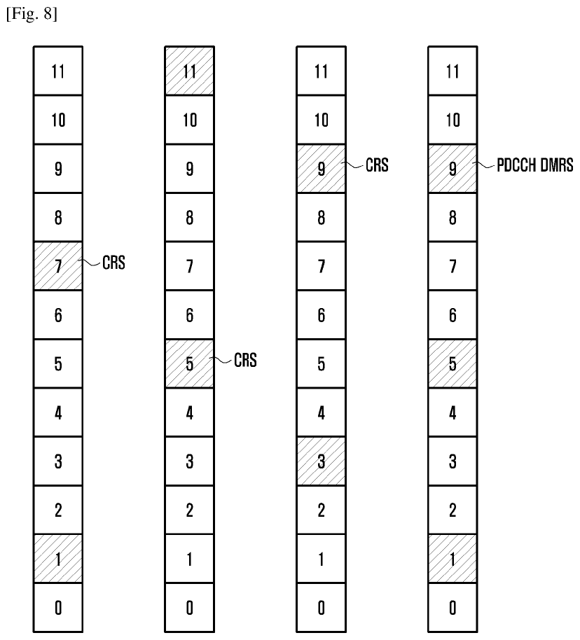

In an example, before adjustment or when the communication system does not coexist with the LTE system, the position of the DMRS of PDCCH is shown in FIG. 7, occupying 3 REs among the 12 REs, position of which is {1,5,9}. While when the communication system coexists with the LTE system, when there is one port for the CRS of LTE and it is {1,7}, {3,9}, {5,11}, the CRS of LTE overlaps with the DMRS of PDCCH, and the CRS will seriously interfere with the DMRS of PDCCH, as shown in FIG. 8, which will affect the reception performance for PDCCH. When there are two ports or four ports for the CRS of LTE and the positions are one of {1, 7, 4, 10}, {0, 6, 3, 9} and {2, 8, 5, 11}, the CRS of LTE overlaps with the DMRS of PDCCH, and the CRS will seriously interfere with the DMRS of PDCCH, as shown in FIG. 9, which will affect the reception performance for PDCCH.

There are the following ways to reduce or eliminate influence caused by the interference of the CRS to the DMRS of PDCCH. The following ways describe some exemplary methods for adjusting the number and/or positions of the REs occupied by the DMRS of PDCCH.

### EXAMPLE 1

The number of the REs occupied by the DMRS of PDCCH is not changed.

When there is only one port for the CRS of LTE, the following methods may be adopted.

One aspect of the method is that when a new communication system coexists with the CRS of LTE, position of the CRS of LTE is configured so that the CRS of LTE does not overlap with the DMRS of PDCCH, that is, the position of the CRS of LTE is configured to be {0,6}, {2,8}, {4,10}, while the position of the CRS of LTE is not configured to be {1,7}, {3,9}, {5,11}. By adopting this method, the number of REs occupied by DMRS of PDCCH and the frequency domain position of Res is not changed, thus ensuring the performance of PDCCH.

Another aspect of the method is that if the LTE communication system has been deployed, it is difficult to reconfigure the CRS of LTE, then the frequency domain position of the DMRS of PDCCH may be changed to avoid the overlap between the DMRS of PDCCH and the CRS of LTE. By adopting this method, the number of the REs occupied by the DMRS of PDCCH is not changed, thus ensuring the performance for PDCCH.

In order to avoid the interference of the CRS of LTE to the DMRS of PDCCH, the position of the DMRS of PDCCH may be adjusted according to the frequency domain position of the CRS of LTE. There are the following methods.

### Method 1:

The UE or base station determines the frequency domain position of the DMRS of PDCCH according to the frequency domain position of the CRS of LTE. For example, the UE may determine the number of REs and/or frequency domain position of the DMRS of PDCCH according to a mapping relationship or a correspondence table between the number of ports and frequency domain position of the CRS and the number of REs and frequency domain position of the DMRS. For example, when the base station transmits the PDCCH, the mapping relationship will be satisfied between the transmitted PDCCH and the CRS of LTE. To alleviate or eliminate a conflict between RE positions occupied by the CRS of LTE and by the DMRS of PDCCH, an offset value of the DMRS of PDCCH in frequency domain may be introduced, so that the position of the DMRS of PDCCH in frequency domain becomes one of {0,4,8}, {1,5,9}, {2,6,10} and {3,7,11}. For example, the frequency domain position of the DMRS of PDCCH is {(1+delta) mod 12, (5+delta) mod 12, (9+delta) mod 12}, and the value of delta is a non-negative integer, delta=any one of {0, 1, 2, 3, 4, 5, 6, 7, 8, 9, 10, 11}. The frequency domain position of the DMRS of PDCCH is determined according to the frequency domain position of at least one CRS of LTE coexisting with the communication system. For example, an achievable example is that when the frequency domain position of the CRS of the LTE coexisting with the communication system is one of {0,6}, {2,8} and {4,10}, the frequency domain position of the DMRS of PDCCH becomes {1,5,9}; and when the frequency domain position of the CRS of the LTE coexisting with the communication system is one of {1,7}, {3,9} and {5,11}, the frequency domain position of the DMRS of PDCCH becomes {2,6,10}. Table 1 lists some examples of the mapping relationship between the number of ports of the CRS of LTE and the frequency domain position of the CRS and the number of REs of the DMRS of PDCCH and the frequency domain position of the DMRS.

Table 1: table of the mapping relationship between the number of ports (n) of the CRS of LTE and the frequency domain position (p) of the CRS and the number of REs of the DMRS of PDCCH and the frequency domain position of the DMRS of PDCCH

TABLE 1

| The number of ports (n) of | The number of REs (a) of |
|---|---|
| the CRS of LTE and the | the DMRS of PDCCH and |
| frequency domain position | the frequency domain position |
| (p) of the CRS | (q) of the DMRS of PDCCH |
| n = 1, p = {0, 6}, {2, 8}, {4, 10} | a = 3, q = {1, 5, 9} |
| n = 1, p = {1, 7} | a = 3, q = {2, 6, 10} |
| n = 1, p = {3, 9} | a = 3, q = {2, 6, 10} |
| n = 1, p = {5, 11} | a = 3, q = {2, 6, 10} |

With this method, the interference of the CRS of LTE to the DMRS of PDCCH may be avoided without additional signaling indication to adjust of the frequency domain position of the DMRS of PDCCH, and the number of the REs occupied by the DMRS of PDCCH is not changed by this method, thus ensuring the performance for PDCCH.

### Method 2:

The UE determines the number of the REs occupied by the DMRS of PDCCH and/or the frequency domain positions of the REs occupied by the DMRS of PDCCH by receiving signaling from the base station. For example, the UE receives signaling to determine an offset value ‘delta’ of the DMRS of PDCCH in frequency domain, so that the position of the DMRS of PDCCH in frequency domain may become one of {0,4,8}, {1,5,9}, {2,6,10} and {3,7,11}. For example, the frequency domain position of the DMRS of PDCCH is {(1+delta) mod 12, (5+delta) mod 12, (9+delta) mod 12}, and the value of delta is a non-negative integer, delta=any one of {0, 1, 2, 3, 4, 5, 6, 7, 8, 9, 10, 11}.

With this method, the frequency domain position of the DMRS of PDCCH may be flexibly adjusted through signaling indication, so as to avoid the interference of the CRS of LTE to the DMRS of PDCCH, and the number of the REs occupied by the DMRS of PDCCH is not changed by this method, thus ensuring the performance for PDCCH.

When there are two ports or four ports for the CRS of LTE, the following methods may be adopted.

The number of REs of the DMRS of PDCCH in one OFDM symbol of one physical resource block (PRB) is kept unchanged at 3.

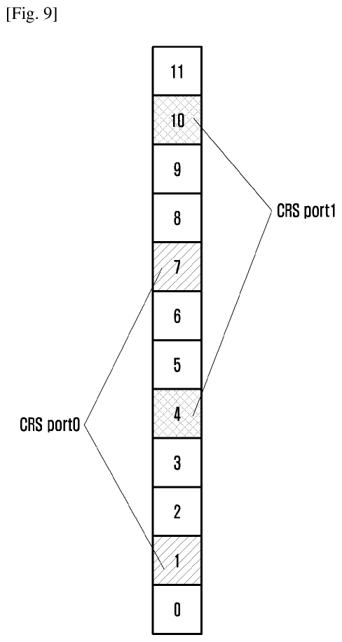

The position of the DMRS of PDCCH is adjusted according to the number of ports and/or position of the CRS of LTE, the number of REs of the DMRS of PDCCH in one OFDM symbol of one physical resource block (PRB) is kept unchanged at 3, the position of the DMRS of PDCCH in frequency domain is determined according to the position of the CRS of LTE that overlaps with the DMRS of PDCCH, and the 3 REs are made to be distributed as evenly as possible. That is, the positions of the REs occupied by the DMRS that do not overlap with the CRS of LTE are kept unchanged, but the positions of the REs occupied by the DMRS that overlap with the CRS of LTE are adjusted, and this adjustment makes intervals among the positions of the REs occupied by the DRMS after adjustment have the smallest differences with each other, that is, the positions of these REs are distributed as evenly as possible within the 12 positions used for carrying information in one OFDM symbol. An example is shown in FIG. 10, when the position of the CRS of LTE is {1,7,4,10}, the position of the DMRS of PDCCH in frequency domain may be changed from {1,5,9} to {2,5,9}.

Alternatively, the UE determines the number of the REs occupied by the DMRS of PDCCH and the frequency domain positions of the REs occupied by the DMRS of PDCCH by receiving the signaling from the base station. For example, the UE receives higher layer signaling configuration to determine that the number of REs of the DMRS of PDCCH in one OFDM symbol of one physical resource block (PRB) is 3, and the positions of REs of the DMRS of PDCCH is {2,5,9}.

With this method, the frequency domain position of the DMRS of PDCCH may be flexibly adjusted through signaling indication, so as to avoid the interference of the CRS of LTE to the DMRS of PDCCH, which also has an effect of simplifying UE implementation.

### EXAMPLE 2

The number of the REs occupied by the DMRS of PDCCH is changed.

When there is only one port for the CRS of LTE, the following methods may be adopted.

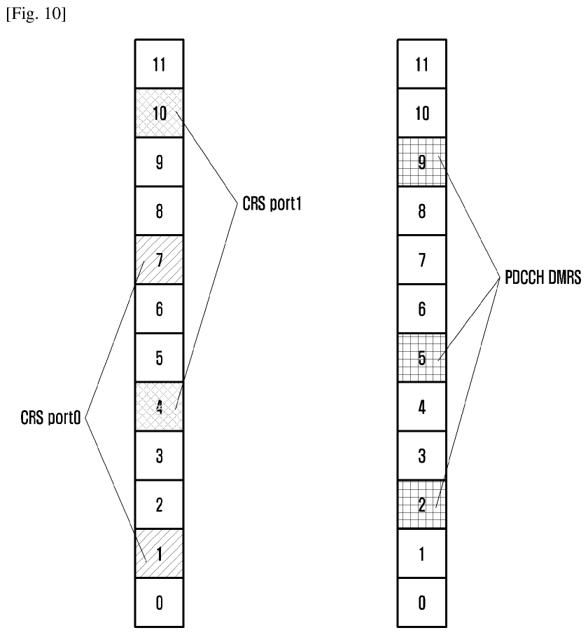

One aspect of the method is that if the DMRS of PDCCH overlaps with the CRS of LTE, the UE does not receive the DMRS of PDCCH at the overlapping position, and the UE only receives the DMRS of PDCCH at the position of the DMRS of PDCCH that does not overlap with the CRS of LTE, as shown in FIG. 11. This method changes the number of the REs occupied by the DMRS of PDCCH. While when the base station transmits the DMRS of PDCCH, it may transmit the DMRS of PDCCH at the position that overlaps with the CRS of LTE, or it may not transmit the DMRS of PDCCH at the position that overlaps with the CRS of LTE.

The advantage of this method is that the frequency domain position of the DMRS of PDCCH needs not to be changed, which reduces the complexity of UE implementation.

In addition, when there are two ports or four ports for the CRS of LTE and the positions of occupied REs are one of {1, 7, 4, 10}, {0, 6, 3, 9}, {2, 8, 5, 11}, the positions of REs occupied by the CRS of LTE overlap with the positions of RES occupied by the DMRS of PDCCH, and the CRS will seriously interfere with the DMRS of PDCCH. At this time, it is difficult to avoid the overlap between the DMRS of PDCCH and the CRS of LTE by shifting the position of the DMRS of PDCCH.

Influence due to the interference of the CRS of LTE to the DMRS of PDCCH may be avoided by adjusting the number of REs of the DMRS of PDCCH in one OFDM symbol of one physical resource block (PRB) to be less than or equal to 3.

When the CRS of LTE in one OFDM symbol of one physical resource block (PRB) occupies four REs, the number of REs of the DMRS of a PDCCH is reduced, so that the DMRS of PDCCH in one OFDM symbol of one physical resource block (PRB) occupies two REs or one RE. In this case, the RE position of the DMRS of PDCCH may be determined by the following methods.

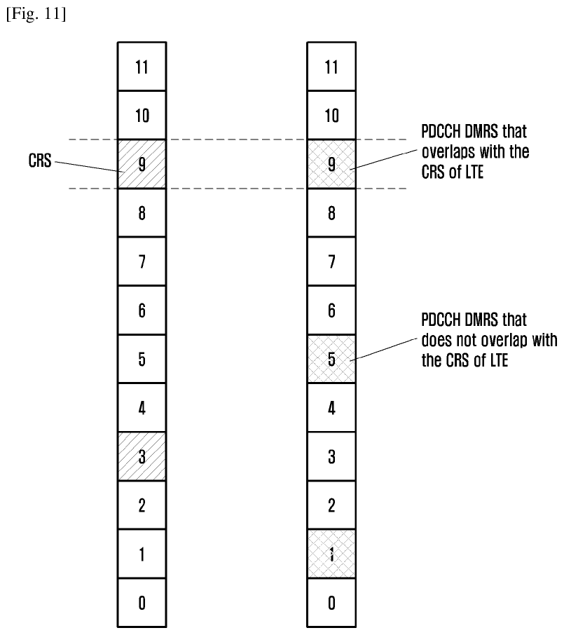

One determination method is to keep the position occupied by the DMRS that does not overlap with the REs occupied by the CRS of LTE among the positions occupied by the DMRS of PDCCH unchanged. An example is shown in FIG. 12, when the position of the CRS of LTE is {1,7,4, 10}, the position of the DMRS of PDCCH in frequency domain may be changed to {5,9}. The advantage of this method is that the ratio of the number of the REs occupied by the DMRS of PDCCH to the number of the REs occupied by the control information of the PDCCH may be kept unchanged, and the position of the DMRS of PDCCH is not changed.

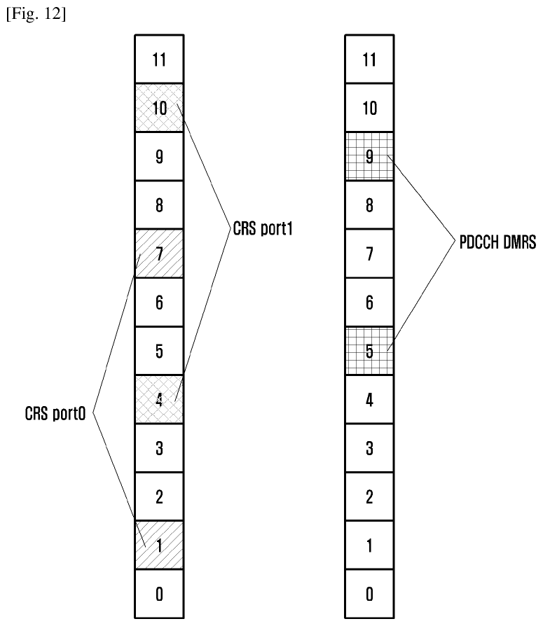

Another determination method is to re-adjust the frequency domain position occupied by the DMRS of PDCCH, so that the REs of the DMRS of PDCCH are distributed as evenly as possible. An example is shown in FIG. 13, when the position of the CRS of LTE is {1,7,4,10}, the position of the DMRS of PDCCH in frequency domain may be changed to {2,8}. The advantage of this method is to keep the ratio of the number of the REs occupied by the DMRS of PDCCH and the number of the REs occupied by the control information of PDCCH unchanged, and to improve the reception performance for PDCCH by making the REs of the DMRS of PDCCH distributed as evenly as possible.

The above two methods are to determine the number of the REs occupied by the DMRS of PDCCH and the frequency domain position occupied by the DMRS of PDCCH through the number of ports and position of the CRS of LTE. The number of the REs occupied by the DMRS of PDCCH and the frequency domain positions of the REs occupied by the DMRS of PDCCH may also be directly indicated through signaling. For example, the UE determines the number of the REs occupied by the DMRS of PDCCH and the frequency domain positions of the REs occupied by the DMRS of PDCCH by receiving the signaling from the base station. For example, the UE receives higher layer signaling configuration to determine that the number of REs of the DMRS of PDCCH in one OFDM symbol of one physical resource block (PRB) is 2, and the positions of the REs of the DMRS of PDCCH are {2,8}.

With this method, the frequency domain position of the DMRS of PDCCH may be flexibly adjusted through signaling indication, so as to avoid the interference of the CRS of LTE to the DMRS of PDCCH as much as possible, and UE implementation may be simplified.

### EXAMPLE 3

The number of the REs occupied by the DMRS of PDCCH may be directly indicated by signaling (which may be higher layer signaling and physical layer signaling, which is not limited herein) or preset by a protocol (the number of REs may be 1,2,3, etc.), and the frequency domain position of the DMRS of PDCCH is determined according to the number of ports and/or position of the CRS of LTE together with the number of the REs occupied by the DMRS of PDCCH indicated by signaling. That is, a mapping relationship between the number of ports and/or position of the CRS of LTE and the number of the REs occupied by the DMRS of PDCCH and the frequency domain position of the DMRS of PDCCH is determined, and an example is shown in Table 2. For example, the UE is indicated by receiving a signaling configuration from the base station that the number of REs of the DMRS of PDCCH in one OFDM symbol of one physical resource block (PRB) is 2, and when receiving another signaling to determine that there is one port for the CRS of LTE and the frequency domain position of the CRS is {1,7}, the frequency domain position of the DMRS of PDCCH is {3,9}; and when receiving another signaling indicating that there are two ports or four ports for the CRS of LTE and the frequency domain position of the CRS is {1,7,4,10}, the frequency domain position of the DMRS of PDCCH is {2, 9}; or, the UE is indicated by receiving a signaling configuration from the base station that the number of REs of the DMRS of PDCCH in one OFDM symbol of one physical resource block (PRB) is 3, and when receiving another signaling to determine that there is one port for the CRS of LTE and the frequency domain position of the CRS is {1,7}, the frequency domain position of the DMRS of PDCCH is {2,5,9}. Table 2 lists some examples of the mapping relationship between the number of ports of the CRS of LTE and the frequency domain position of the CRS and the number of REs of the DMRS of PDCCH and the frequency domain position of the DMRS.

Table 2: table of the mapping relationship between the number of ports (n) of the CRS of LTE and the frequency domain position (p) of the CRS and the number of REs of the DMRS of PDCCH and the frequency domain position of the DMRS of PDCCH

TABLE 2

| The number of | The number of ports (n) of | The frequency |
|---|---|---|
| REs occupied | the CRS of LTE and the | domain position of |
| by the DMRS | frequency domain position | the DMRS of |
| of PDCCH | (p) of the CRS | PDCCH |
| 3 | n = 1, p = {0, 6}, | {1, 5, 9} |
| | {2, 8}, {4, 10} | |
| 3 | n = 1, p = {1, 7} | {2, 5, 9} or {0, 5, 9}, |
| | | or {2, 6, 10} |
| 3 | n = 1, p = {3, 9} | {1, 5, 8} or {1, 5, 10}, |
| | | or {2, 6, 10} |
| 3 | n = 1, p = {5, 11} | {1, 4, 9} or {1, 6, 9}, |
| | | or {2, 6, 10} |
| 3 | n = 2, or 4p = { 1, 7, 4, 10} | {2, 5, 9} or {0, 5, 9} |
| 3 | n = 2, or 4p = {0, 6, 3, 9} | {1, 5, 8} or {1, 5, 10} |
| 3 | n = 2, or 4p = {2, 8, 5, 11} | {1, 4, 9} or {1, 6, 9} |
| 2 | n = 1, p = {1, 7} | {3, 9} |
| 2 | n = 2, or 4 | {2, 9} |
| | p = {1, 7, 4, 10} | |

The advantage of this method is to determine the number of REs of the DMRS of PDCCH according to frequency selectivity of a channel, which can not only ensure the performance of channel estimation, but also save the number of the REs occupied by the DMRS of PDCCH as much as possible.

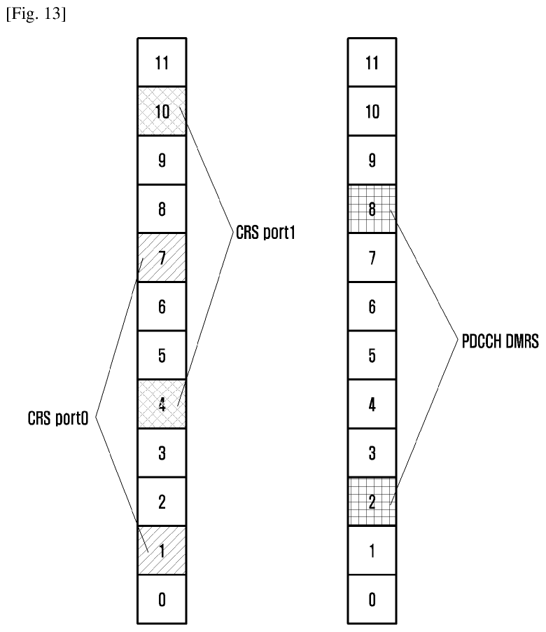

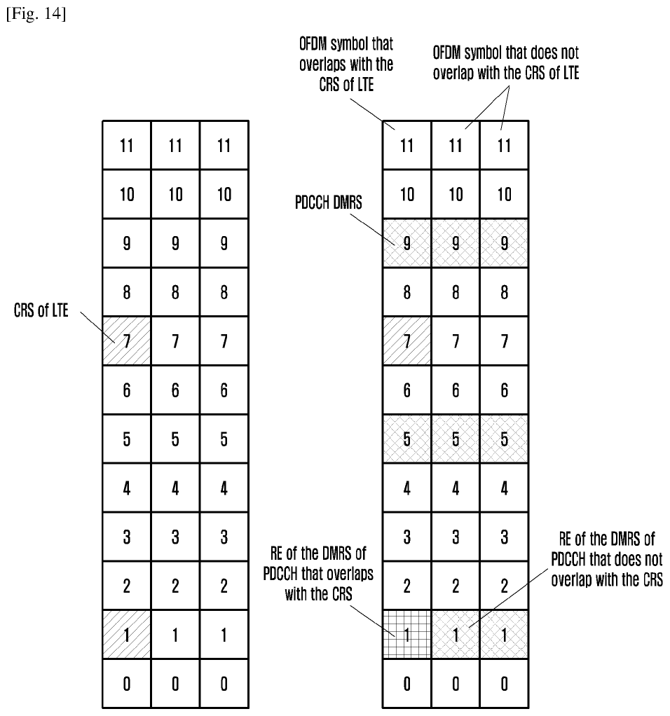

The above description is all about the determination of the number of REs of the DMRS of PDCCH of the OFDM symbol interfered by the CRS of LTE and the frequency domain positions of the REs of the DMRS, while candidates of PDCCH may occupy more than one OFDM symbol. For example, when the number of ports of the CRS of LTE is 1 and the Control resource set (CORESET) includes 2 or 3 symbols, PDCCH is interfered by the CRS of LTE only in the first OFDM symbol, and the second OFDM symbol and the third OFDM symbol are not interfered by the CRS of LTE, as shown in FIG. 14. Alternatively, when the number of ports of the CRS of LTE is 4 and the Control resource set (CORESET) includes 3 symbols, PDCCH is interfered by the CRS of LTE in the first OFDM symbol and the second OFDM symbol, and the third OFDM symbol is not interfered by the CRS of LTE, as shown in FIG. 15.

When some OFDM symbols in CORESET are interfered by the CRS of LTE, and some OFDM symbols are not interfered by the CRS of LTE, there are the following methods to determine the number of the REs occupied by the DMRS of PDCCH and the frequency domain position occupied by the DMRS of PDCCH.

### Method 1:

When some OFDM symbols in CORESET are interfered by the CRS of LTE, and

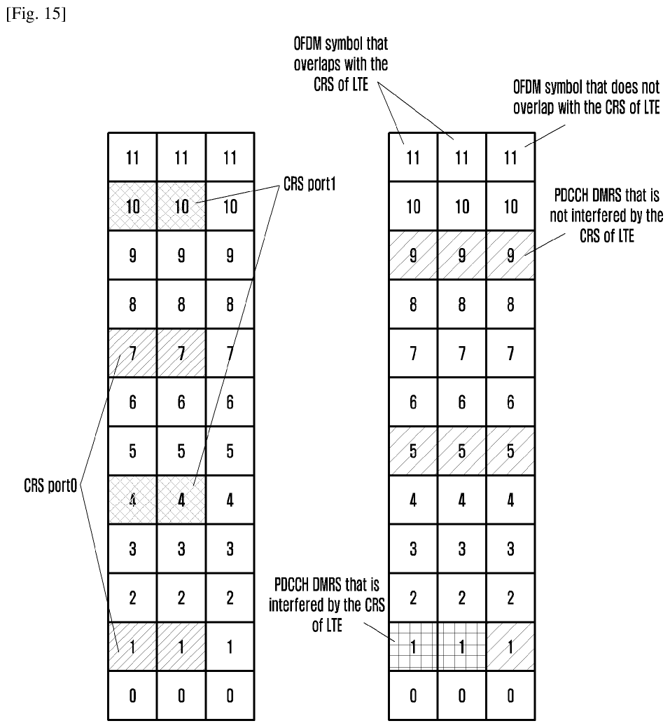

some OFDM symbols are not interfered by the CRS of LTE, the number of the REs occupied by the DMRS of PDCCH and the frequency domain position occupied by the DMRS of PDCCH of OFDM symbols that are interfered by the CRS of LTE are determined according to the above-described method, and the number of the REs occupied by the DMRS of PDCCH and the frequency domain position occupied by the DMRS of PDCCH of OFDM symbols that are not interfered by the CRS of LTE remain unchanged (that is, the number of REs of the DMRS of PDCCH is 3 and the frequency domain position occupied by the DMRS of PDCCH is {1,5,9}). For example, as shown in FIG. 16, when the number of ports of the CRS of LTE is 1 and the Control resource set (CORESET) includes 3 symbols, PDCCH is interfered by the CRS of LTE only in the first OFDM symbol, and the second OFDM symbol and the third OFDM symbol are not interfered by the CRS of LTE. The number of REs of the DMRS of PDCCH of the first OFDM symbol is 3, and the frequency domain position occupied by the DMRS of PDCCH is {2,6,10}. The second OFDM symbol and the third OFDM symbol are not interfered by the CRS of LTE, and the number of REs of the DMRS of PDCCH of the second OFDM symbol and third OFDM symbol is 3, and the frequency domain position occupied by the DMRS of PDCCH is {1,5,9}.

The advantage of this method is that the number of the REs occupied by the DMRS of PDCCH and the frequency domain position occupied by the DMRS of PDCCH are changed as little as possible, so that the reception performance for PDCCH is optimized.

### Method 2:

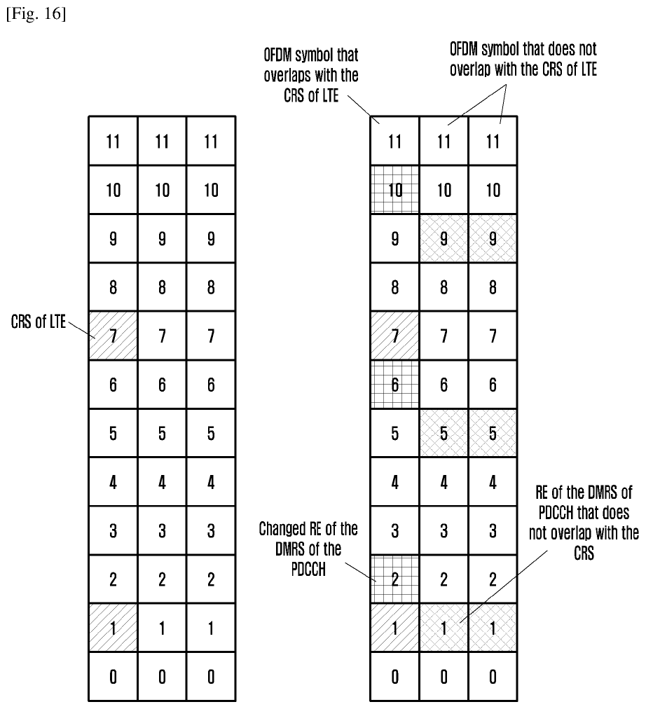

When some OFDM symbols in CORESET are interfered by the CRS of LTE, and some OFDM symbols are not interfered by the CRS of LTE, the number of the REs occupied by the DMRS of PDCCH and the frequency domain position occupied by the DMRS of PDCCH of all OFDM symbols in CORESET are the same as the number of the REs occupied by the DMRS of PDCCH and the frequency domain position occupied by the DMRS of PDCCH of OFDM symbols that are interfered by the CRS of LTE. For example, the base station may transmit indication information to the UE to indicate that the number and frequency domain positions of the REs occupied by the DMRS in PDCCH of OFDM symbols that are not interfered by the CRS of LTE are the same as the number and frequency domain positions of the REs occupied by the DMRS in PDCCH of OFDM symbols that are interfered by the CRS of LTE. For example, as shown in FIG. 17, when the number of ports of the CRS of LTE is 1 and the Control resource set (CORESET) includes 3 symbols, PDCCH is interfered by the CRS of LTE only in the first OFDM symbol, and the second OFDM symbol and the third OFDM symbol are not interfered by the CRS of LTE. The number of REs of the DMRS of PDCCH of the first OFDM symbol is 3, and the frequency domain position occupied by the DMRS of PDCCH is {2,6,10}. The second OFDM symbol and the third OFDM symbol are not interfered by the CRS of LTE, and the number of REs of the DMRS of PDCCH of the second OFDM symbol and third OFDM symbol is 3, and the frequency domain position occupied by the DMRS of PDCCH is {2,6,10}.

The advantage of this method is that the number of the REs occupied by the DMRS of PDCCH and the frequency domain position occupied by the DMRS of PDCCH of all symbols in CORESET may be kept unchanged, thus simplifying the implementation of UE.

### EMBODIMENT 2

For an existing PDCCH, the power of each of the 3 REs occupied by the DMRS of the PDCCH is the same as the power of each of the remaining 9 REs occupied by the control information of the PDCCH in one OFDM symbol of one physical resource block (PRB). However, when the position of PDCCH overlaps with the position of the CRS of LTE, in order to avoid the interference of the CRS of LTE to PDCCH, the UE does not receive the DMRS or control information of PDCCH on the REs of PDCCH that overlap with the CRS of LTE, which results in the reduction of the number of REs on which the base station can transmit information in one OFDM symbol of one physical resource block (PRB). To ensure that in this case, the transmission power of the base station in each OFDM symbol is constant, the transmission power of other REs of PDCCH (that is, REs that do not overlap with the CRS of LTE) may be adjusted or increased. Alternatively, in order to ensure the channel estimation performance for PDCCH, the base station may only increase the power at REs that are actually used to transmit DMRS in some cases. Examples will be described below.

In an implementation, the UE determines a ratio of the power of each RE of the REs occupied by the DMRS of PDCCH to the power of each RE of the REs occupied by the control information of PDCCH according to signaling.

In addition, the UE detects PDCCH according to the ratio of the power of each RE of the REs occupied by the DMRS of PDCCH to the power of each RE of the REs occupied by the control information of PDCCH.

The signaling may be higher layer signaling configuration or physical layer signaling, etc., which may directly indicate the ratio of the power of each RE of the REs occupied by the DMRS of PDCCH to the power of each RE of the REs occupied by the control information of PDCCH. For example, the ratio of the power of each RE of the REs occupied by the DMRS of PDCCH to the power of each RE of the REs occupied by the control information of PDCCH is configured by higher layer signaling as 1.5.

This signaling may be another higher layer signaling configuration or physical layer signaling, etc., which may indicate the number of ports of the CRS of LTE and the frequency domain position of the CRS, and the UE determines the ratio of the power of each RE of the REs occupied by the DMRS of PDCCH to the power of each RE of the REs occupied by the control information of PDCCH according to the number of ports of the CRS of LTE and the frequency domain position of the CRS.

The method of determining the ratio of the power of each RE of the REs occupied by the DMRS of PDCCH to the power of each RE of the REs occupied by the control information of PDCCH will be described in detail by way of example below.

When the position of the PDCCH overlaps with the CRS of LTE, in order to avoid the interference of the CRS of LTE to the PDCCH, the UE does not receive the DMRS or control information of PDCCH on the REs of PDCCH that overlap with the CRS of LTE, thus the number of REs that the base station can use to transmit information in one OFDM symbol of one physical resource block (PRB) will be reduced, and the transmission power of other REs of the PDCCH may be adjusted or increased to ensure that the transmission power of the base station in each OFDM symbol is constant. For the base station, there are the following methods to adjust or increase the transmission power of other REs of PDCCH.

### Method 1:

The power of each RE of the REs of the DMRS of PDCCH and the power of each RE of the REs of the control information of PDCCH are kept the same.

When increasing the power of the REs of the DMRS or control information of PDCCH, the power of each RE of the REs of the DMRS of PDCCH and the power of each RE of the REs of the control information of PDCCH are kept the same, the power of REs that would have been used for transmission (which is stopped) is evenly distributed to the REs of the DMRS of PDCCH and the REs of the control information of PDCCH, so that the ratio of the power of each RE of the REs of the DMRS of PDCCH and the power of each RE of the REs of the control information of PDCCH is 1. As an example, when the position of the CRS of LTE is {1,7,4,10}, the position of the DMRS of PDCCH in frequency domain may be changed to {2,8}. At this time, the UE does not receive on REs at {1,7,4,10}, and the UE receives on REs at {0,2,3,5,6,8,9,11}. Herein, the DMRS of PDCCH is received at {2,8}, and the control information of PDCCH is received at {0,3,5,6,9,11}. The power of PDCCH at {1,7,4,10} is evenly distributed to REs at {0,2,3,5,6,8,9,11}, and the power of REs at {0,2,3,5,6,8,9,11} becomes 1.5 times of the original power thereof. The advantage of this method is that the power of each RE of the REs occupied by the DMRS of PDCCH and the power of each RE of the REs occupied by PDCCH control information are kept the same, and the UE does not need to recalculate the ratio between the power of the REs occupied by the DMRS of PDCCH and the power of the REs occupied by PDCCH control information.

### Method 2:

The ratio between the power of each RE of the REs of the DMRS of PDCCH and the power of each RE of the REs of the control information of PDCCH may be changed.

According to the number of the REs occupied by the DMRS of PDCCH and the number of the REs occupied by the control information of PDCCH in one OFDM symbol of one physical resource block (PRB), as well as the number of ports and the frequency domain positions of the REs for the CRS of LTE, the ratio of the power of each RE of the REs occupied by the DMRS of PDCCH to the power of each RE of the REs occupied by the control information of PDCCH is determined. The following schemes are possible:

One scheme is that when the number of the REs occupied by the DMRS of PDCCH in one OFDM symbol of one physical resource block (PRB) is 3, the transmission power of REs occupied by the DMRS of PDCCH is unchanged, while if the REs occupied by the PDCCH control information overlap with the REs of the CRS of LTE, the UE does not receive the PDCCH control information at REs among the REs occupied by the PDCCH control information that overlap with the REs of the CRS of LTE, and the power of the REs occupied by PDCCH control information is unchanged. With this method, the ratio of the power of each RE of the REs occupied by the DMRS of PDCCH to the power of each RE of the REs occupied by PDCCH control information remains unchanged, still being 1.

Another feasible scheme is that when the number of the REs occupied by the DMRS of PDCCH in one OFDM symbol of one physical resource block (PRB) is 3, the transmission power of the DMRS of PDCCH is unchanged, and if the REs occupied by the PDCCH control information overlap with the REs of the CRS of LTE, the UE does not receive the PDCCH control information at REs among the REs occupied by the PDCCH control information that overlap with the REs of the CRS of LTE, the power of the REs occupied by PDCCH control information is increased, making the power of REs occupied by all PDCCH control information in one OFDM symbol of one physical resource block (PRB) equal to the power of REs occupied by all PDCCH control information in one OFDM symbol of one physical resource block (PRB) when the REs occupied by all PDCCH control information in one OFDM symbol of one physical resource block (PRB) do not overlap with the CRS of LTE, and then, the ratio of the power of each RE of the REs occupied by the DMRS of PDCCH to the power of each RE of the REs occupied by the PDCCH control information may be calculated according to the change of the power of the REs occupied by the PDCCH control information, and the ratio may be less than 1 at this time. For example, when there is no CRS of LTE that overlaps with the REs occupied by the PDCCH control information, the UE receives the DMRS and control information of PDCCH in 12 REs of one OFDM symbol of one physical resource block (PRB), the transmission power of each RE is p, and the PDCCH control information is received in 9 REs of one OFDM symbol of one physical resource block (PRB). The total transmission power of PDCCH control information of 9 REs of the base station is 9p. If there are 2 REs of the CRS of LTE that overlap with the REs occupied by PDCCH control information, the UE receives PDCCH control information on 7 REs, and the base station increases the transmission power of the 7 REs occupied by PDCCH control information to make the total transmission power of the base station on the 7 REs of PDCCH control information to be 9p, then the transmission power on each of the REs is 9p/7, while the power of each RE of the REs occupied by the DMRS of PDCCH is p, thus the ratio of the power of each RE of the REs occupied by the DMRS of PDCCH to the power of each RE of the REs occupied by PDCCH control information is p/(9p/7)=7/9. With this method, the power of one OFDM symbol of one physical resource block (PRB) may be kept constant, and all available power may be fully used to ensure the reception performance for PDCCH.

Another feasible scheme is that when the number of the REs occupied by the DMRS of PDCCH in one OFDM symbol of one physical resource block (PRB) is 3, if the REs occupied by the PDCCH control information overlap with the REs of the CRS of LTE, and the UE does not receive the PDCCH control information at REs among the REs occupied by the PDCCH control information that overlap with the REs of the CRS of LTE, then the power of the REs occupied by the DMRS and control information of PDCCH is increased, so that the power of all REs occupied by the DMRS and control information of PDCCH in one OFDM symbol of one physical resource block (PRB) is the same as the power of all REs occupied by the DMRS and control information of PDCCH in one OFDM symbol of one physical resource block (PRB) when all REs occupied by the PDCCH control information in one OFDM symbol of one physical resource block (PRB) do not overlap with the CRS of LTE. For example, when the CRS of LTE does not overlap with the REs occupied by PDCCH control information, the UE receives the DMRS and control information of PDCCH in 12 REs of one OFDM symbol of one physical resource block (PRB), the transmission power of each RE is p, and the PDCCH control information is received in 9 REs of one OFDM symbol of one physical resource block (PRB). The total transmission power of PDCCH control information of 9 REs of the base station is 9p. If there are 2 REs of the CRS of LTE that overlap with the REs occupied by PDCCH control information, the UE receives PDCCH control information on 7 REs, then the base station increases the transmission power of the 7 REs of PDCCH control information and the 3 REs of the DMRS of PDCCH, so that the total transmission power of the base station on these 10 REs is 12p, thus the transmission power of each RE is 12p/10. Therefore, the ratio of the power of each RE of the REs occupied by the DMRS of PDCCH to the power of each RE of the REs occupied by PDCCH control information is 1. With this method, the ratio of the power of the REs occupied by the DMRS of PDCCH to the power of the REs occupied by PDCCH control information may be kept constant, thus simplifying UE implementation.

Another scheme is that when the number of the REs occupied by the DMRS of PDCCH in one OFDM symbol of one physical resource block (PRB) is less than 3, the power of the REs occupied by the DMRS of PDCCH is increased, so that the power of all REs occupied by the DMRS of PDCCH in one OFDM symbol of one physical resource block (PRB) is equal to the power of the 3 REs when the number of all REs occupied by the DMRS of PDCCH in one OFDM symbol of one physical resource block (PRB) is equal to 3. For example, when the CRS of LTE does not overlap with the REs occupied by the DMRS of PDCCH, the UE receives the DMRS of PDCCH in 3 REs of one OFDM symbol of one physical resource block (PRB), and the total transmission power of the base station on the 3 REs occupied by the DMRS of PDCCH is P. If there is 1 RE of the CRS of LTE that overlaps with the REs occupied by the DMRS of PDCCH, the UE receives the DMRS of PDCCH in 2 REs, then the base station increases the transmission power on the 2 REs so that the total transmission power of the base station on the 2 REs is P. With this method, the performance of channel estimation of PDCCH may be guaranteed.

Another scheme is that when the REs occupied by the DMRS of PDCCH in one OFDM symbol of one physical resource block (PRB) is less than 3 and the REs occupied by the control information of PDCCH in one OFDM symbol of one physical resource block (PRB) is less than 9, the power of the REs occupied by the DMRS of PDCCH is increased while the power of the REs occupied by the control information of PDCCH is kept unchanged, and the total power of all REs occupied by PDCCH in one OFDM symbol of one physical resource block (PRB) is kept unchanged. For example, when the CRS of LTE does not overlap with the REs occupied by the DMRS of PDCCH and the REs occupied by the control information of the PDCCH, the UE receives the DMRS of PDCCH in 3 REs of one OFDM symbol of one physical resource block (PRB) and receives the control information of the PDCCH in 9 REs of one OFDM symbol of one physical resource block (PRB). The total transmission power of 12 REs of the base station is 12p. If there is 1 RE of the CRS of LTE that overlaps with the RE occupied by the DMRS of PDCCH, and there is 1 RE of the CRS of LTE that overlaps with the RE occupied by the control information of PDCCH, the UE receives the DMRS of PDCCH on 2 REs and receives the control information of PDCCH on 8 REs, then the base station increases the transmission power of the 2 REs of the DMRS of PDCCH to 4p, so that the sum of the total transmission power 4p of the base station on the 2 REs of the DMRS of PDCCH and the total transmission power 8p of the base station on the 8 REs occupied by the control information of PDCCH is equal to 12p. At this time, the power of each RE occupied by the DMRS of PDCCH is 2p, and the power of each RE occupied by the control information of PDCCH is p, so that the ratio of the power of each RE occupied by the DMRS of PDCCH to the power of each RE occupied by the control information of PDCCH is 2. With this method, the channel estimation performance for PDCCH may be guaranteed, and the power of one OFDM symbol of one physical resource block (PRB) may be kept constant.

The above description is a method for determining the power of REs occupied by the DMRS of PDCCH of OFDM symbols interfered by the CRS of LTE and the power of the REs occupied by PDCCH control information. For example, when the number of ports of the CRS of LTE is 1, and the Control resource set (CORESET) includes 2 or 3 symbols, PDCCH is interfered by the CRS of LTE only in the first OFDM symbol, and the second OFDM symbol and the third OFDM symbol are not interfered by the CRS of LTE. Alternatively, when the number of ports of the CRS of LTE is 4 and the Control resource set (CORESET) includes 3 symbols, PDCCH is interfered by the CRS of LTE in the first OFDM symbol and the second OFDM symbol, and the third OFDM symbol is not interfered by the CRS of LTE.

When some OFDM symbols in CORESET are interfered by the CRS of LTE and some OFDM symbols are not interfered by the CRS of LTE, there are the following methods to determine the ratio between the power of each RE occupied by the DMRS of PDCCH and the power of each RE occupied by the control information of PDCCH.

### Method 1:

When some OFDM symbols in CORESET are interfered by the CRS of LTE and some OFDM symbols are not interfered by the CRS of LTE, the power of RES occupied by the DMRS of PDCCH of OFDM symbols that are interfered by the CRS of LTE and the power of REs of control information of the PDCCH are determined according to the method described above, and the power of REs occupied by the DMRS of PDCCH of OFDM symbols that are not interfered by the CRS of LTE and the power of REs of control information of the PDCCH remain unchanged. In addition, if the power of REs occupied by the DMRS of PDCCH of OFDM symbols that are interfered by the CRS of LTE and the power of the REs of the control information of the PDCCH are changed, the UE needs to know the ratio between the changed power of REs occupied by the DMRS of the PDCCH and/or the power of REs of the control information of the PDCCH and the power of REs occupied by the DMRS of PDCCH of OFDM symbol that are not interfered by the CRS of LTE and/or the power of REs of the control information of the PDCCH. The UE can directly obtain the ratio by receiving signaling, or obtain the ratio by calculation with the knowledge of the number of ports of the CRS of LTE and the frequency domain position of the CRS.

For example, when the number of ports of the CRS of LTE is 1 and the Control resource set includes 2 OFDM symbols, the PDCCH is interfered by the CRS of LTE in the first OFDM symbol, and the second OFDM symbol is not interfered by the CRS of LTE. In an implementation, the power of each RE occupied by the DMRS of PDCCH in the second OFDM symbol and/or the power of each RE occupied by the control information of the PDCCH is p, the power of each RE occupied by the DMRS of PDCCH in the first OFDM symbol is p, and the power of each RE occupied by the control information of the PDCCH is 9/7p.

The advantage of this method is that the power of REs occupied by the DMRS of PDCCH and the power of control information of PDCCH are changed as little as possible, so that the reception performance for PDCCH is optimal.

### Method 2:

When some OFDM symbols in CORESET are interfered by the CRS of LTE and some OFDM symbols are not interfered by the CRS of LTE, the power of REs occupied by the DMRS of PDCCH and the power of REs occupied by control information of PDCCH of all OFDM symbols in CORESET are the same as the power of REs occupied by the DMRS of PDCCH of OFDM symbols that are interfered by the CRS of LTE and the power of REs occupied by control information of the PDCCH. For example, the base station may transmit indication information to the UE, indicating that the power of each RE occupied by the DMRS in PDCCH of OFDM symbols that are not interfered by the CRS of LTE and the power of each RE occupied by control information are the same as the power of each RE occupied by the DMRS in PDCCH of OFDM symbols that are interfered by the CRS of LTE and the power of each RE occupied by control information, respectively.

For example, when the number of ports for the CRS of LTE is 1 and the Control resource set includes 2 OFDM symbols, PDCCH is interfered by the CRS of LTE in the first OFDM symbol, the second OFDM symbol is not interfered by the CRS of LTE, and the power of REs occupied by the DMRS of PDCCH in the first OFDM symbol is p, the power of REs of PDCCH control information is all p, and the power of REs occupied by the DMRS of PDCCH in the second OFDM symbol and/or the power of REs of PDCCH control information is all p.

By adopting this method, it is ensured that the power of REs of all OFDM is the same, and the complexity of UE implementation is reduced.

### EMBODIMENT 3

In a case where the CRS of LTE overlaps with the REs used to carry information in PDCCH, in order to reduce the influence caused by the interference of the CRS of LTE, the UE only receives PDCCH on the REs that do not overlap with the CRS of LTE, so that the number of REs available for each CCE is reduced compared with the number of REs when PDCCH is not interfered by the CRS of LTE. At the same time, in order to reduce the complexity of protocol modification, the composition structure of each CCE may be kept unchanged, and the CCE Aggregation Level (AL) of PDCCH candidates may be changed, for example, from the current 1,2,4,8,16 to N of 1,2,3,4,5,6,7,8,9,10,11,12,13,14,15,16,17,18,19,20, [symbol] , M, thus the reception performance of PDCCH is guaranteed, and the RE number of PDCCH is saved as much as possible. Herein, M represents the maximum value among CCE AL candidates, and N represents the number of CCE AL candidates. The UE can determine M and N and each of the N candidate CCE ALs through protocol preset or by receiving higher layer signaling configuration.

The possible CCE AL of PDCCH candidates will change according to the number of ports and frequency domain position of the CRS of LTE.

The possible CCE AL of the current PDCCH candidate is {1,2,4,8,16}.

The UE can determine the possible CCE AL of PDCCH candidates by receiving signaling.

The UE can detect PDCCH according to the determined CCE AL of PDCCH candidates.

As the REs occupied by the PDCCH in one OFDM symbol of one physical resource block (PRB) overlap with the CRS of LTE, in order to reduce the interference of the CRS of LTE, the UE only receives the PDCCH on the REs that do not overlap with the CRS of LTE, so that the available number of REs of each CCE is reduced compared with that when the PDCCH is not interfered by the CRS of LTE. At the same time, in order to reduce the complexity of protocol modification, the composition structure of each CCE remains unchanged, while the CCE Aggregation Level (AL) of PDCCH candidates may be changed, from the current 1,2,4,8,16 to N of 1,2,3,4,5,6,7,8,9,10,11,12,13,14,15,16,17,18,19,20, thus ensuring the reception performance for PDCCH, and at the same time save the number of REs of PDCCH as much as possible. The UE can determine N and each CCE AL among the N candidate CCE ALs through protocol preset or by receiving higher layer signaling configuration. Herein, N is a positive integer. This method can ensure the reception performance for PDCCH.

An example scheme is that when the PDCCH is interfered by the CRS of LTE with two or four ports, the possible CCE AL of the PDCCH candidate is {1,2,4,8,16,32} or the possible CCE AL of the PDCCH candidate is {2,4,8,16,32}. At this time, due to the reduction of the number of available REs in CCE, reception performance for PDCCH without the interference of the CRS of LTE can be achieved by adjusting the possible CCE ALs of PDCCH candidates.

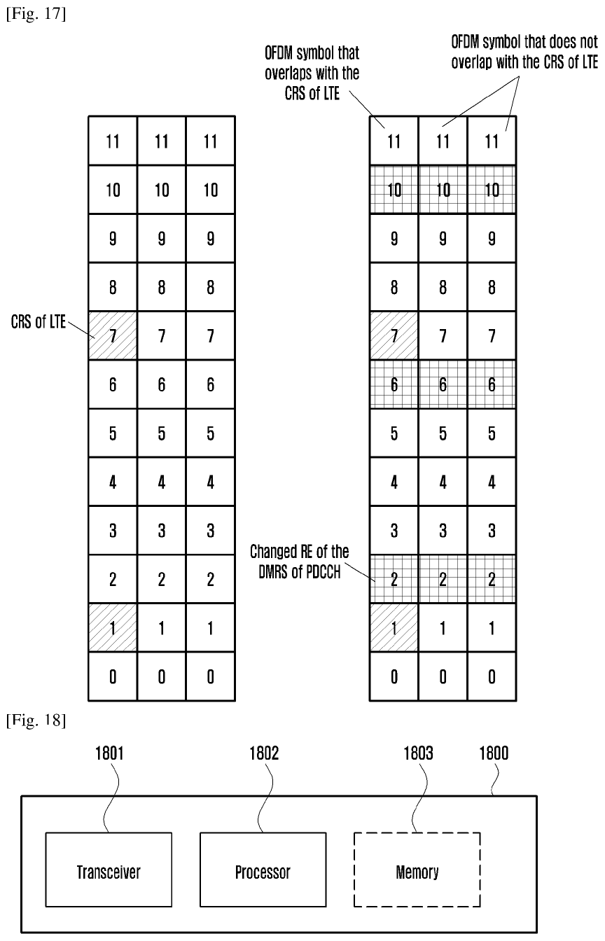

FIG. 18 illustrates a simplified block diagram of a hardware structure of a communication device 1800 according to an embodiment of the present disclosure, which may be configured to implement any one or more of the methods according to various embodiments of the present disclosure. Therefore, it should be understood that the communication device 1800 may be a user equipment or a base station or a part thereof described in the present disclosure. It should be understood that the base station may be a 5G base station (such as gNB, ng-eNB) or a 4G base station (such as eNB), or other types of access nodes, or a part of the base station which may be, for example, a distribution unit (DU), a centralized unit (CU), a control plane part of the centralized unit, a user plane part of the centralized unit, etc.

As shown in FIG. 18, the communication device 1800 includes a transceiver 1801, a processor 1802, or alternatively a memory 1803.

The transceiver 1801 is configured to receive and/or transmit signals.

The processor 1802 is operatively connected to the transceiver 1801 and/or the memory 1803. The processor 1802 may be implemented as one or more processors for operating according to any one or more of the methods described in various embodiments of the present disclosure.

The memory 1803 is configured to store computer programs and data. The memory 1803 may include a non-transitory memory for storing operations and/or code instructions executable by the processor 1802. The memory 1803 may include non-transitory programs and/or instructions readable by the processor that, when executed, cause the processor 1802 to implement the steps of any one or more methods according to various embodiments of the present disclosure. The memory 1803 may also include a random access memory or buffer(s) to store intermediate processing data from various functions executed by the processor 1802.

Those of ordinary skill in the art will realize that the description of the communication configuration method of the present disclosure is only illustrative, and is not intended to be limiting in any way. Other embodiments will be readily apparent to those of ordinary skill in the art having the benefit of the present disclosure.

For the sake of clarity, not all conventional features of the implementations of the methods and apparatuses related to communication configuration of the present disclosure are shown and described. Of course, it should be understood that in the development of any such actual implementation of the methods and devices related to communication configuration, many implementation-specific decisions may need to be made in order to achieve the developers' specific goals, such as compliance with the constraints related to applications, systems, networks and businesses, and these specific goals will vary from implementation to implementation and from developer to developer.

The modules, processing operations and/or data structures described according to the present disclosure may be implemented using various types of operating systems, computing platforms, network devices, computer programs and/or general-purpose machines. In addition, those of ordinary skill in the art will realize that less general-purpose devices such as hard-wired devices, Field Programmable Gate Array (FPGA), application specific integrated circuits (ASIC), etc. may also be used. In the case that a method including a series of operations and sub-operations is implemented by a processor, computer or machine, and those operations and sub-operations may be stored as a series of non-transitory code instructions readable by the processor, computer or machine, they may be stored on tangible and/or non-transitory media.

The modules of the methods and devices related to communication configuration described herein may include software, firmware, hardware, or any (multiple) combination of software, firmware or hardware suitable for the purpose described herein.

In the methods related to communication configuration described herein, various operations and sub-operations may be performed in various orders, and some of the operations and sub-operations may be optional.

Although the foregoing disclosure of the present application has been made by non-limiting illustrative embodiments, these embodiments may be arbitrarily modified within the scope of the appended claims without departing from the spirit and essence of the present disclosure.

Although some exemplary embodiments of the present disclosure have been shown and described, it should be understood by those skilled in the art that these embodiments may be modified without departing from the principle and spirit of the present disclosure whose scope is defined by the claims and their equivalents.

1. A method performed by a user equipment (UE) in a wireless communication system, the method comprising:
receiving first information indicating a number of ports for a first reference signal and positions of REs occupied by the first reference signal; and
receiving a PDCCH based on at least one of the first information or second information related to the PDCCH,
wherein REs occupied by a second reference signal in the PDCCH do not overlap with the REs occupied by the first reference signal.

2. The method according to claim 1, wherein the second information includes a number or positions of the REs occupied by the second reference signal in the PDCCH.

3. The method according to claim 1, wherein the first information is received from a base station, and
wherein the second information is received from a base station or is preset.

4. The method according to claim 1, wherein receiving a PDCCH based on at least one of the first information or second information related to the PDCCH further comprises:
receiving the PDCCH based on a mapping relationship between the number of ports for the first reference signal and the positions of the REs occupied by the first reference signal and positions of the REs occupied by the second reference signal in the PDCCH,
wherein the mapping relationship is related to the number of the REs occupied by the second reference signal in the PDCCH indicated in the second information.

5. The method according to claim 1, wherein control information in the PDCCH occupies REs that do not overlap with the REs occupied by the second reference signal and the REs occupied by the first reference signal,
wherein the second information includes a ratio of power of the REs occupied by the second reference signal in the PDCCH to power of the REs occupied by the control information in the PDCCH, and
wherein the ratio is determined based on the first information or is received from a base station.

6. The method according to claim 1, wherein the second information includes third information related to a control channel element aggregation level (CCE AL) of a PDCCH candidate.

7. The method according to claim 1, further comprising:
receiving fourth information indicating that a second OFDM symbol which does not overlap with the REs occupied by the first reference signal uses the same PDCCH receiving configuration as a first OFDM symbol which overlaps with the REs occupied by the first reference signal; and
according to the fourth information, receiving the PDCCH in the second OFDM symbol based on at least one of the first information and the second information related to the PDCCH.

8. A method performed by a base station in a wireless communication system, the method comprising:
transmitting first information indicating a number of ports for a first reference signal and positions of REs occupied by the first reference signal to a UE; and
transmitting a PDCCH to the UE,
wherein REs occupied by a second reference signal in the PDCCH do not overlap with the REs occupied by the first reference signal.

9. The method according to claim 8, further including:
transmitting second information related to the PDCCH to the UE, wherein the second information includes a number or positions of the REs occupied by the second reference signal in the PDCCH,
wherein there is a mapping relationship between the positions of the REs occupied by the second reference signal in the PDCCH and the number of ports for the first reference signal and the positions of the REs occupied by the first reference signal, and
wherein the mapping relationship is related to the number of the REs occupied by the second reference signal in the PDCCH indicated in the second information.

10. The method according to claim 8, wherein control information in the PDCCH occupies REs that do not overlap with the REs occupied by the second reference signal and the REs occupied by the first reference signal, and
wherein the second information includes a ratio of power of the REs occupied by the second reference signal in the PDCCH to power of the REs occupied by the control information in the PDCCH.

11. The method according to claim 8, wherein the second information includes third information related to a control channel element aggregation level (CCE AL) of a PDCCH candidate.

12. The method according to claim 8, further including:
transmitting fourth information indicating that a second OFDM symbol which does not overlap with the REs occupied by the first reference signal uses the same PDCCH receiving configuration as a first OFDM symbol which overlaps with the REs occupied by the first reference signal to the UE.

13. A user equipment (UE) in a wireless communication system, the UE comprising:
a transceiver configured to transmit and receive signals; and
a controller coupled to the transceiver and configured to:
receive first information indicating a number of ports for a first reference signal and positions of REs occupied by the first reference signal, and
receive a PDCCH based on at least one of the first information or second information related to the PDCCH,
wherein REs occupied by a second reference signal in the PDCCH do not overlap with the REs occupied by the first reference signal.

14. The UE according to claim 13,
wherein the controller is further configured to:
receive the PDCCH based on a mapping relationship between the number of ports for the first reference signal and the positions of the REs occupied by the first reference signal and positions of the REs occupied by the second reference signal in the PDCCH,
wherein the mapping relationship is related to the number of the REs occupied by the second reference signal in the PDCCH indicated in the second information.

15. A base station in a wireless communication system, the base station comprising:
a transceiver configured to transmit and receive signals; and
a controller coupled to the transceiver and configured to:
transmit first information indicating a number of ports for a first reference signal and positions of REs occupied by the first reference signal to a UE, and
transmit a PDCCH to the UE,
wherein REs occupied by a second reference signal in the PDCCH do not overlap with the REs occupied by the first reference signal.
